(19) United States
(12) Patent Application Publication
(10) Pub. No.: US 2003/0010876 A1
(43) Pub. Date: Jan. 16, 2003

(54) Rest device for the hand and a support device for the forearm

(76) Inventor: Abood Issa, Ekero (SE)

Correspondence Address: Rolf Fasth, Fasth Law Offices, 189 Curtis Drive, Longview, WA, 98632-5374, US

(21) Appl. No.: 10/182,111

(22) PCT Filed: Jan. 25, 2001
(86) PCT No.: PCT/SE01/00142

(30) Foreign Application Priority Data
Jan. 26, 2000 (SE) 0000232-9

(51) Int. Cl. B68G 5/00; B43L 15/00

(52) U.S. Cl. 248/118.5; 248/118.1; 248/118; 248/918; 345/163

(57) ABSTRACT

The present invention relates to a rest device for the hand and a support device for the forearm of a person, who performs repeated rotational, lifting and pressure moments with his/her hand e.g. moments during the use of a computer mouse, other intensive work moments with the hand as well as during the rehabilitation of the hand and the arm subsequent to various types of injuries. The device comprises a resilient moveable rest and support part (1), which receives the forearm and has a plane central part (2) as well as at least two sector parts (3, 4, 5, 6) which extend outwards from the central part at an angle and in pairs are arranged in the same half of the device as well as a part (7, 8, 9, 10) which extends downwards at an angle to the plane central part, the rest and support part (1) being supported by resilient elements, which exert a pressure, preferably compression springs (11, 12, 13, 14) or the like, arranged in a vertical direction below the sector parts (3, 4, 5, 6) adjacent the circumference (P) and consequently on each side of the part (7, 8, 9, 10), which extends downwards the lifting, lowering and rotational movements of the hand and its fingers being facilitated and resiliently damped by means of the rest and support part due to the reaction properties of the springs.

### TECHNICAL FIELD

The present invention relates to a rest device for the hand and a support device for the forearm of a person, who performs repeated hand movements such as rotational, lifting and pressure motions with his/her hand and its fingers, e.g. when using a computer mouse, during various intensive working moments with the hand as well as during a rehabilitation of hands and arms having various types of stress injuries.

### BACKGROUND ART

In the above-mentioned technical field there are many different types of solutions regarding constructions designed to support the forearm, when a work is performed using the hand and its fingers. These constructions are often clumsy and difficult to use, since they are not ergonomically designed and consequently reduces the freedom of movement of the user. Others are constructed in a simple way and consequently sometimes are not very efficient.

A few examples of such already known constructions are described in U.S. Pat. Nos. 4,973,176, 5,265,835, 5,335,888 and 5,490,647.

### BRIEF DISCLOSURE OF THE INVENTIVE IDEA

The object of the present invention is to eliminate the above-mentioned drawnbacks of known rest and support devices for the hand and the arm, when the hand and its fingers are used, and to allow the hand to occupy a position, which is comfortable for the body and in this way to spare the shoulders, the arms and the back during these activites as well as to prevent, that i.a. the disability “mouse arm” arises.

When a person is using a computer mouse for an extended period of time a fatigue of the shoulder arises, causing the hand to not be able to move sufficiently rapidly.

The object of the present invention is to generate a reaction against the activity of the hand and in this way counteract this phenomen.

According to the inventive idea the above-mentioned problems are solved by the measure, that said device comprises a resilient moveable rest and support part, which receives the forearm, comprises a plane central part as well as at least two hump-like sector parts, which extend upwards at an angle from the central part and which in pairs are positioned on the same half of the device, as well as at least one part, which extends downwards between said sector parts at an angle to said plane central part, the rest and support device being supported by resilient elements, which exert a pressure, preferably compression springs or the like, positioned below each sector part adjacent its circumference and consequently on each side of one of the parts, which extend downwards, the lifting, lowering and rotational movements of the hand and its fingers being facilitated and the forearm thereby being resiliently damped by means of the rest and support part thanks to the reaction properties of the springs.

According to the invention a device is obtained, which is easy to handle and which counteracts the development of fatigue of the shoulder, since it facilitates the various movements of the hand and the fingers, is flexible regarding its utilization, is easy and concequently economic to manufacture, has a long life and can be used by different persons regardless of the size of the hand and the arm.

### BRIEF DESCRIPTION OF DRAWINGS

The invention will now be described, reference being made to the enclosed drawings, in which:

FIG. 1 shows a first emodiment of the invention, seen from above.

FIG. 2 shows the first embodiment, seen from below, provided with four support legs.

FIG. 3 shows in a lateral view the rest and support part in FIGS. 1 and 2 with dashed lines for cavities, designed to receive support legs.

FIG. 4 shows a support leg, recieved in one of the cavities in FIG. 3 as well as a compression spring, arranged in the cavity.

FIG. 5 shows in a lateral view another embodiment of the invention, which comprises a rest and support part as well as a lower part.

FIG. 6 shows the rest and support part in FIG. 5 seen from above.

FIG. 7 shows the rest and support part in cross-section along line A-A in FIG. 6.

FIG. 8 shows the rest and support part in cross-section along line B-B in FIG. 5.

FIG. 9 shows the lower part of the embodiment in FIG. 5 seen from above and

FIG. 10 shows a cross-section of the lower part in FIG. 5 along line A-A in FIG. 6.

### DETAILED DESCRIPTION OF PREFFERRED EMBODIMENTS OF THE INVENTION

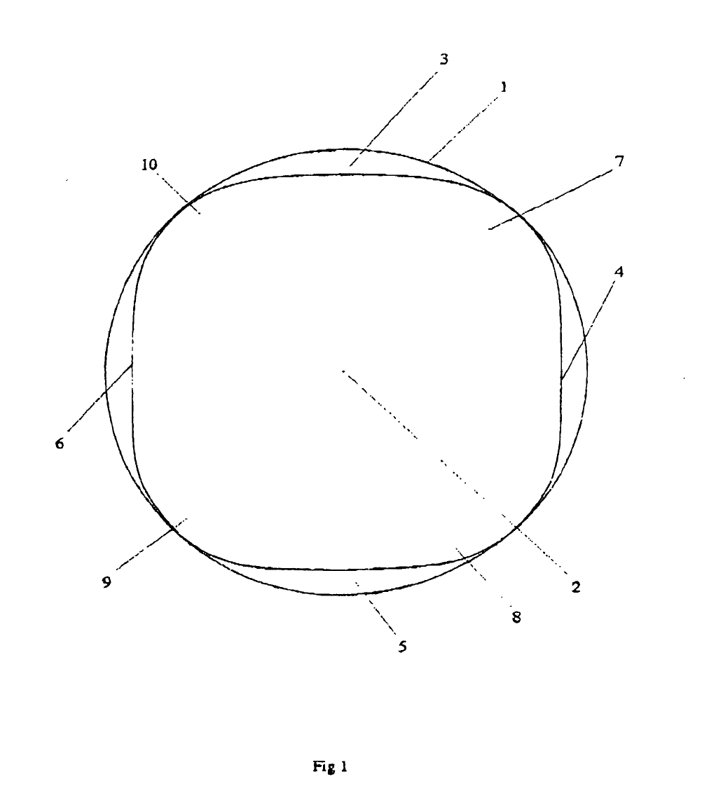

FIG. 1 shows a first embodiment of the invention, seen from above. In FIGS. 1-10 it is shown, that the device comprises a rest and support part 1, which has a mainly round, convex shape with a plane smaller circular central part 2 as well as four hump-shaped sector parts 3,4,5,6 which extend upwards at an angle and in pairs are positioned on the same half of the device as well as between said parts, at an angle to the plane central part 2, parts 7,8,9,10 which extend downwards, the device being supported by compression springs 11,12,13,14 disposed in a vertical direction below each sector part 3,5,5,6 preferably adjacent its circumference P and concequently on each side of parts 7,8,9,10 which extend downwards the lifting lowering and rotational movements of the hand being facilitated when the forearm has been positioned along the same line as two of parts 7,8,9,10 which extend downwards and is supported by the central part 2 of the device and consequently is resiliently damped by rest and support part 1 due to the reaction properties of springs 11,12,13,14.

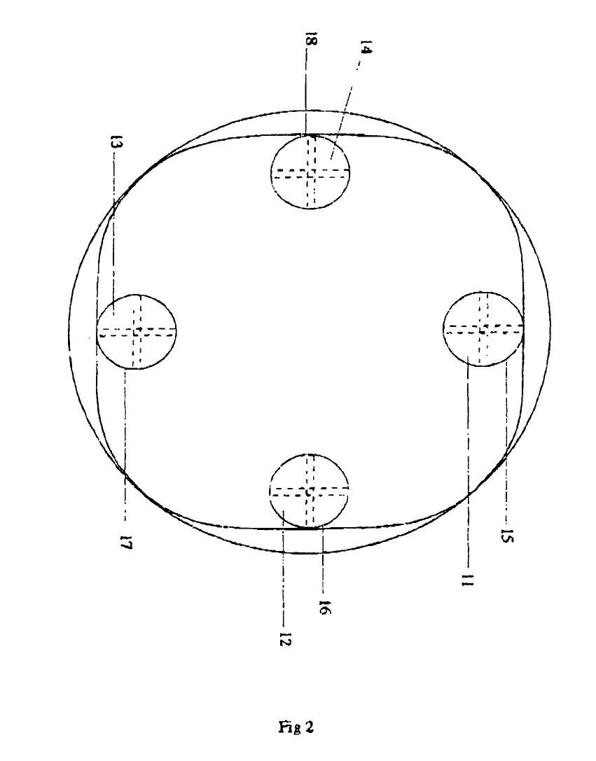

FIG. 2 shows the rest and support part of the first embodiment, seen from below, provided with four support legs 15,16,17,18 in which compression springs 11,12,13,14 are disposed.

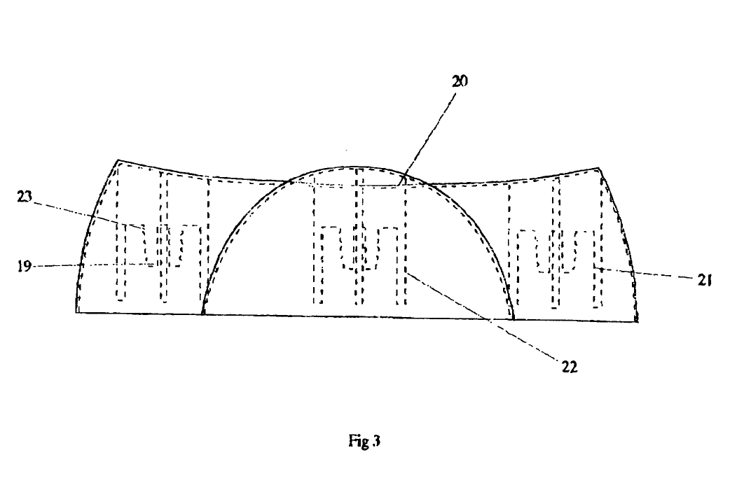

In FIGS. 3 and 4 cavities 19,20,21,22 are shown with dashed lines, positioned in rest and support part 1 for springs 11,12,13,14 and support legs 15,16,17,18. Cavities 19,20,21,22 as well as support legs 15,16,17,18 are provided with inner resilient conical pins designed to recieve compression springs 11,12,13,14 when the legs are mounted in cavities 19,20,21,22.

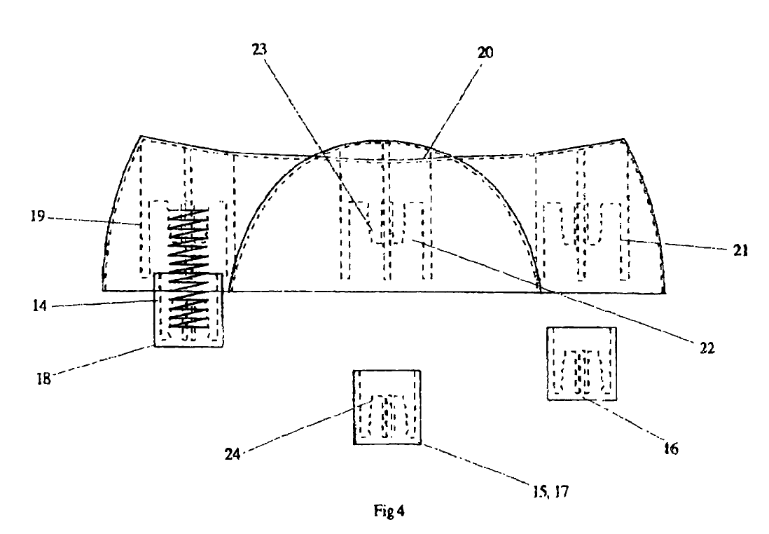

In FIG. 5 another embodiment of the invention is shown, in a lateral view, which comprises a rest and support part 1 as well as a lower part 25, which comprises a plate 26, which with circular parts, arranged around its circumference and provided with recesses 29,30,31,32 for compression springs 11,12,13,14 is positioned in a vertical direction between rest and support part 1 and the lower part.

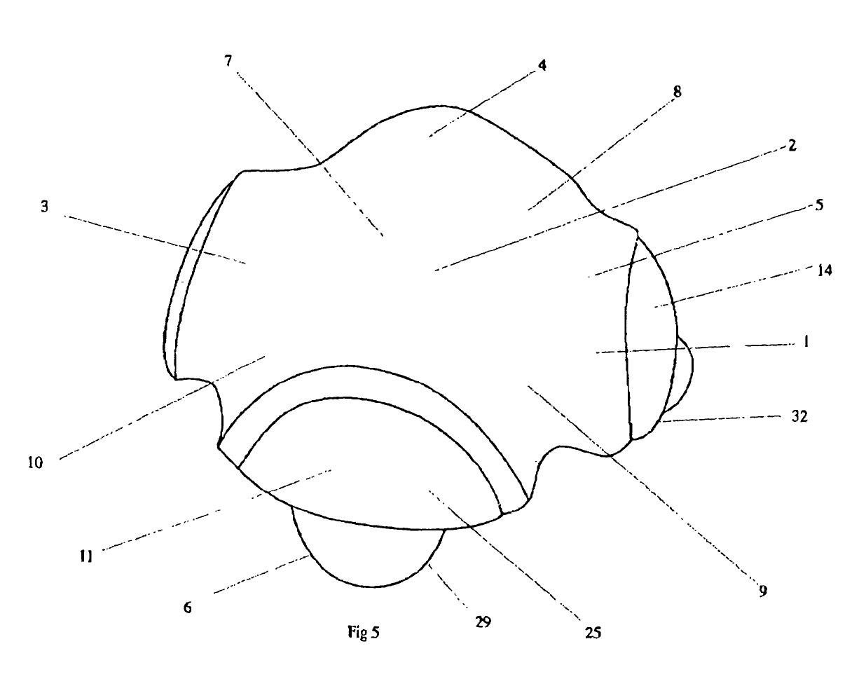

FIG. 6 shows the rest and support part of the embodiment in FIG. 5 seen from above. A tension spring 27 is in its one end fastened to the central part of rest and support part 1 and in its other end fastened to the central part of plate 26 of the lower part.

FIG. 7 shows a cross-section of the rest and support part in FIG. 6 along line A-A in FIG. 5 in which the fastener of tension spring 27 in the rest and support part is shown at 28.

The hump-shaped sector parts 4,5,6 and the parts, which extend downwards are also shown.

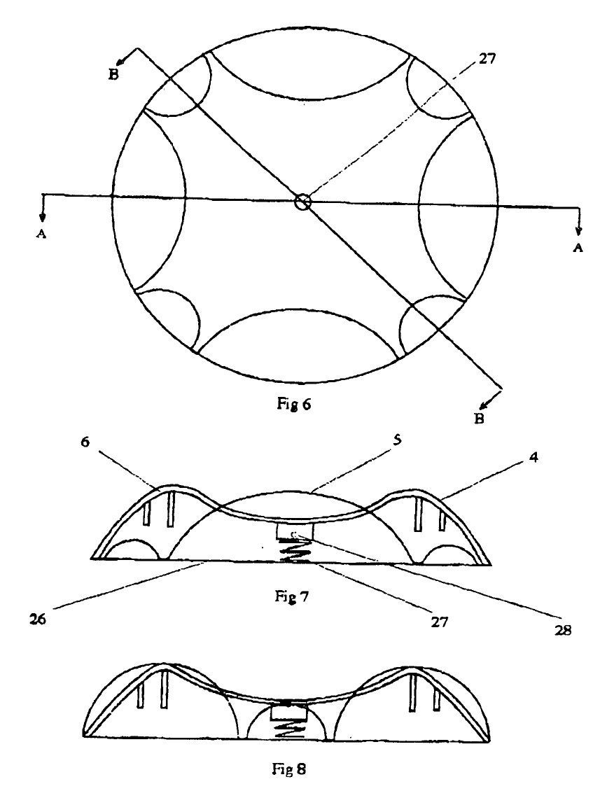

FIG. 8 shows a cross-section through the rest and support part in FIG. 6 along line B-B in FIG. 5.

FIG. 9 shows lower part 25 in FIG. 5 seen above with tension spring 27 in the central part as well as compression springs 11,12,13,14 which are supported by support means at its circumference. Around the circumference of plate 26 the circular parts with recesses 29,30,31, 32 for the compression springs are arranged.

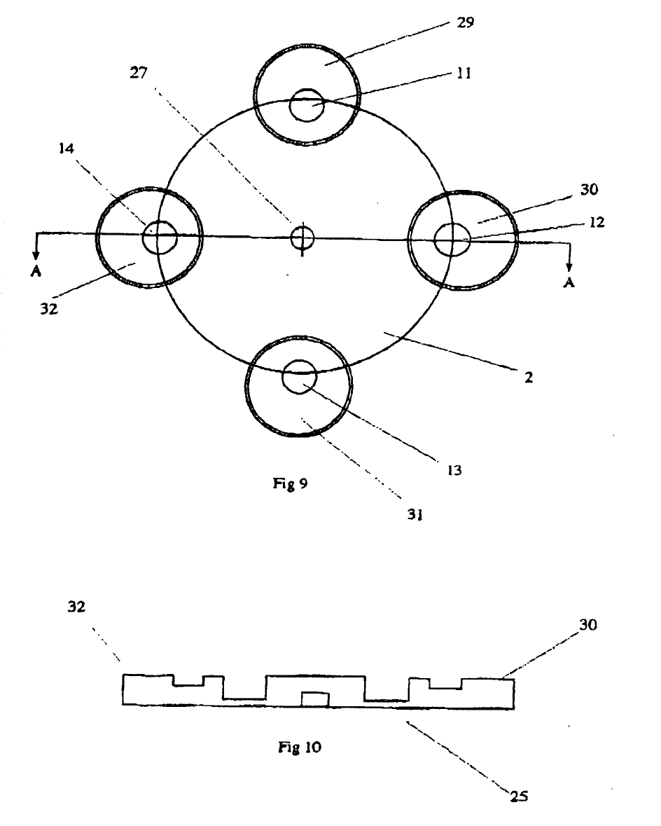

FIG. 10 shows lower part 25 in cross-section along line A-A in FIG. 7 with the fastener for tension spring 27 as well as the parts with recesses 29,30,31,32 for the compression springs.

The compression springs can be selected among all variants of resilient elements, which can exert a pressure.

The invention can also be utilized during computer use for disabled persons, who use wheel chairs. The device is then positioned on a table, arranged adjacent or on the wheel chair and allows the user to support his/her arm in a position, which is comfortable for the back and the user does not have bend his/her back and exert a pressure on arm and shoulders, when the computer mouse is used.

The invention can also be used when rehabilitating other typer of stress iniuries, such as tennis elbow, developed during tennis play, or caused by work for a long time with the manufacturing of printed circuit cards, assembly work and paperwork. The device can be equiped with a vibrating element in order to massage the the user's arm by means of vibrations.

1. A rest device for the hand and a support device for the forearm of a person, who performs repeated rotational, lifting and pressing moments with the hand and its fingers when using e.g. a computer mouse, during various intensive work moments with the hand as well as during rehabilitation of hands and arms having various types of stress iniuries,
characterized in that the device comprises a resilient movable rest and support part (1) which will receive the forearm and comprises a plane central part (2) as well as at least two hump-shaped sector parts (3,4,5,6) which extend upwards at an angle from the central part and in pairs are positioned on the same half of the device as well as parts (7,8,9,10) which extend downwards to the plane central part at an angle, the rest and support device (1) being supported by means of resilient elements, which exert a pressure preferably compression springs (11,12,13,14) or the like, arranged in a vertical direction below the hump-shaped sector parts (3,4,5,6) adjacent the circumference (P) and consequently on each side of the part (7,8,9,10) which extends downwards the lifting, lowering and rotational movements of the hand and its fingers being facilitated and resiliently damped by means of the rest and support part due to reaction properties of the springs.

2. A rest and support device according to claim 1,
characterized in that the sector parts (3,4,5,6) are four in number.

3. A rest and support device according to claim 2,
characterized in that a tension spring (27) is fastened to the central part of the support device (1) and to the central part of a lower part (25).

4. A rest and support device according to any of claims 1-3,
characterized in that a vibration element is mounted on the rest and support device in order to produce vibrations, which massage the arm.
